(19) United States
(12) Patent Application Publication
(10) Pub. No.: US 2026/0049594 A1
(43) Pub. Date: Feb. 19, 2026

(54) MODULAR THERMOPLASTIC WEB STRUCTURE FOR WIND POWER GENERATION, MANUFACTURING METHOD THEREFOR, AND WIND TURBINE BLADE

(71) Applicant: Envision Energy Co., Ltd., Jiangsu (CN)

(72) Inventors: Hao MA, Jiangsu (CN); Xiaodong CHEN, Jiangsu (CN); Hansen WU, Jiangsu (CN); Xiangyang ZHANG, Jiangsu (CN); Junsong AN, Jiangsu (CN); Giancarlo GIROLOMINI, Jiangsu (CN)

(21) Appl. No.: 19/286,196

(22) Filed: Jul. 30, 2025

Related U.S. Application Data
(63) Continuation of application No. PCT/CN2025/089068, filed on Apr. 15, 2025.

(30) Foreign Application Priority Data
Aug. 13, 2024 (CN) 202411108287.X

(51) Int. Cl. F03D 1/06; B29D 99/00; B29K 101/12; B29K 105/08

(52) U.S. Cl. CPC F03D 1/0675; B29D 99/0028; B29K 2101/12; B29K 2105/0872; F05B 2280/6013

(57) ABSTRACT

The present disclosure relates to a modular thermoplastic web structure for wind power generation, a manufacturing method therefor, and a wind turbine blade. The modular thermoplastic web structure includes: two continuous thermosetting web flanges fixedly connectable to a wind turbine blade housing; and a thermoplastic modular interlayer, disposed between the two continuous thermosetting web flanges and having two opposite ends fixedly and respectively connected to the two continuous thermosetting web flanges.

### CROSS-REFERENCE TO RELATED APPLICATIONS

The present application is a continuation of PCT Patent Application No. PCT/CN2025/089068, entitled “MODULAR THERMOPLASTIC WEB STRUCTURE FOR WIND POWER GENERATION, MANUFACTURING METHOD THEREFOR, AND WIND TURBINE BLADE,” filed on Apr. 15, 2025, which claims priority to Chinese Patent Application No. 202411108287.X, entitled “MODULAR THERMOPLASTIC WEB STRUCTURE FOR WIND POWER GENERATION, MANUFACTURING METHOD THEREFOR, AND WIND TURBINE BLADE,” filed on Aug. 13, 2024, the entire disclosure of which is incorporated herein by reference in its entirety.

### TECHNICAL FIELD

The present disclosure belongs to the technical field of wind turbines, and in particular to a modular thermoplastic web structure for wind power generation, a manufacturing method therefor, and a wind turbine blade.

### BACKGROUND

Currently, conventional wind turbine blades use thermosetting resins and vacuum infusion processes to fabricate webs, which suffer from long production times and are prone to infusion defects such as microcracks in the web and poor impregnation. As wind turbine blades get increasingly larger, web molds also need to be correspondingly lengthened and expanded, resulting in increased investment costs. Meanwhile, thermosetting webs cannot be recycled or reused, while full-thermoplastic webs face challenges such as high manufacturing difficulty and poor interfacial performance.

For example, in the method for manufacturing a web for wind turbine blades disclosed in CN202110474817.2, fiber-reinforced composite materials are used to produce multiple web modules. Each web module includes a flat plate body and multiple reinforcing members, where the reinforcing members connected to the flat plate body. The multiple web modules are connected together to form a web for wind turbine blades. For example, the wind turbine blade web and its forming method disclosed in patent application CN115807731A use pultruded components and core materials for co-infusion, but cannot control infusion defects. Additionally, the shear-resistant web disclosed in patent application CN107923365A uses discrete springs to fix the panels. All the above-mentioned patent applications use thermosetting materials, and their webs cannot be recycled. Although U.S. Pat. Nos. 11,035,339B2 and 10,697,425B2 adopt the design of thermoplastic webs, they fail to effectively address the issue of interfacial performance, making them difficult to be rapidly utilized.

### SUMMARY

The present disclosure aims to provide a modular thermoplastic web structure for wind power generation, a manufacturing method therefor, and a wind turbine blade.

According to a first aspect of the present disclosure, there is provided a modular thermoplastic web structure for wind power generation, which includes: two continuous thermosetting web flanges fixedly connectable to a wind turbine blade housing; and a thermoplastic modular interlayer, disposed between the two continuous thermosetting web flanges and having two opposite ends fixedly and respectively connected to the two continuous thermosetting web flanges.

According to a second aspect of the present disclosure, there is provided a manufacturing method for a modular thermoplastic web structure. The method includes: (1) preparing a thermoplastic skin layer using thermoplastic pre-preg tape, compounding the thermoplastic skin layer with a core material layer to obtain a thermoplastic modular interlayer, and cutting the thermoplastic modular interlayer to appropriate dimensions; (2) preparing two continuous thermosetting web flanges using thermosetting resin and dry reinforcing fibers; and (3) performing surface pretreatment on the thermoplastic modular interlayer, and fixedly connecting the resultant thermoplastic modular interlayer to the two continuous thermosetting web flanges. Alternatively, the method includes: (A) preparing a thermoplastic skin layer using thermoplastic pre-preg tape, compounding the thermoplastic skin layer with a core material layer to obtain a thermoplastic modular interlayer, and cutting the thermoplastic modular interlayer to appropriate dimensions; and (B) performing surface pretreatment on the thermoplastic modular interlayer, laying dry reinforcing fibers between web flange molds and the thermoplastic modular interlayer, and infusing and curing to form two continuous thermosetting web flanges fixedly connected to two opposite ends of the thermoplastic modular interlayer. Alternatively, the method includes: (I) preparing a thermoplastic skin layer using thermoplastic pre-preg tape, compounding the thermoplastic skin layer with a core material layer to obtain a thermoplastic modular interlayer, and cutting the thermoplastic modular interlayer to appropriate dimensions; and (II) performing surface pretreatment on the thermoplastic modular interlayer, laying dry reinforcing fibers in a space between a wind turbine blade housing and the thermoplastic modular interlayer, and infusing and curing to form two continuous thermosetting web flanges fixedly connected to two opposite ends of the thermoplastic modular interlayer.

According to a third aspect of the present disclosure, there is provided a wind turbine blade, which includes a wind turbine blade housing and the modular thermoplastic web structure for wind power generation as provided in the first aspect above.

The modular thermoplastic web structure for wind power generation according to the present disclosure enables stable production of wind turbine blade webs, reduces the cost of production parts, ensures stable product quality and performance, and mitigates potential infusion defects and CoPQ (cost of poor quality), among other benefits.

### BRIEF DESCRIPTION OF THE DRAWINGS

FIG. 1 is a front view of a modular thermoplastic web structure during installation with a wind turbine blade;

FIG. 2 is a side view of the modular thermoplastic web structure during installation with the wind turbine blade;

FIG. 3 is a schematic diagram showing the preparation process of a thermoplastic modular interlayer;

FIG. 4 is a schematic diagram of surface pretreatment performed on the thermoplastic modular interlayer;

FIG. 5 is a schematic diagram showing the assembly of continuous thermosetting web flanges, in prefabricated form, and the thermoplastic modular interlayer;

FIG. 6 is a schematic diagram showing the assembly of a continuous thermosetting web flange and the thermoplastic modular interlayer by using co-infusion; and

FIG. 7 is a schematic diagram showing the assembly of a continuous thermosetting web flange, a wind turbine blade shell, and the thermoplastic modular interlayer by using co-infusion.

Reference numerals in the accompanying drawings are listed as follows:
10 thermoplastic modular interlayer, 11 continuous thermosetting web flange, 12 first intermediate layer;
21 thermoplastic pre-preg tape, 22 thermoplastic skin layer, 23 core material layer, 24 second intermediate layer;
31 third intermediate layer;
40 flange mold.

### DETAILED DESCRIPTION OF THE EMBODIMENTS

The present disclosure will be described in detail below in conjunction with the accompanying drawings and specific embodiments. The embodiments are implemented on the premise of the technical solution of the present disclosure, providing detailed implementation methods and specific operational procedures. However, the scope of protection of the present disclosure is not limited to the following embodiments.

It should be noted that in the description of the present disclosure, the technical terms “central”, “up”, “down”, “left”, “right”, “vertical”, “horizontal”, “inner”, “outer”, etc., indicate the orientation or positional relationship based on the orientation or positional relationship shown in the accompanying drawings. This is solely for the purpose of facilitating the description of the present disclosure and simplifying the description, and in no way indicates or implies that the devices or elements referred to must have a specific orientation, or be constructed or operated in a specific orientation. Therefore, it cannot be understood as a limitation on the present disclosure. Additionally, the terms “first”, “second”, “third”, etc., are used for descriptive purposes only and should not be understood as indicating or implying relative importance.

It should be noted that in the description of the present disclosure, unless otherwise explicitly specified and defined, the terms such as “installation”, “connection”, “fixation”, etc. should be understood in a broad sense. For example, “connection” may refer to fixed connection, detachable connection, or integral connection; mechanical connection or electrical connection; direct connection, or indirect connection through an intermediary. It may further refer to the internal connectivity between two components. For those of ordinary skill in the art, the specific meanings of the above terms in the present disclosure should be understood according to the specific circumstances.

In the following embodiments or examples, unless otherwise specified, the functional components or structures are all conventional components or conventional structures used in the art to achieve the corresponding functions; and unless otherwise specified, the processing or preparation techniques are all conventional techniques in the art.

To achieve stable production and effective recycling of wind turbine blade webs, embodiments of the present disclosure provide a modular thermoplastic web structure for wind power generation, which includes: two continuous thermosetting web flanges 11 fixedly connectable to a wind turbine blade housing; and a thermoplastic modular interlayer 10, disposed between the two continuous thermosetting web flanges 11 and having two opposite ends fixedly and respectively connected to the two continuous thermosetting web flanges 11.

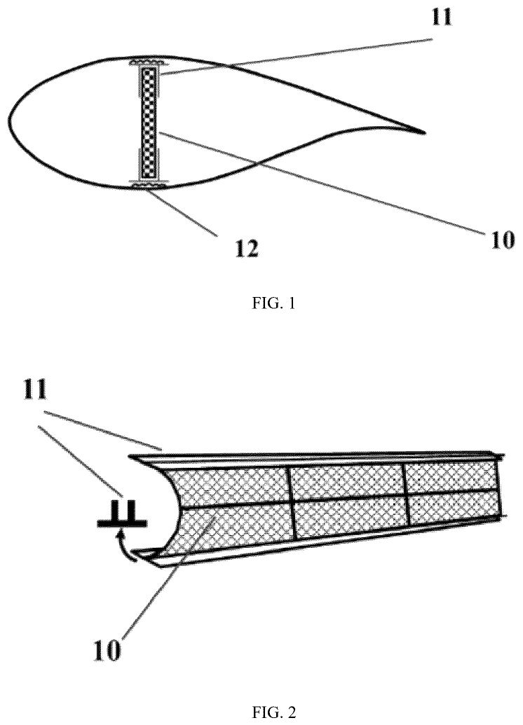

During specific assembly, as shown in FIGS. 1 to 3, the continuous thermosetting web flange 11 may be connected to the blade housing via a first intermediate layer 12 formed by conventional structural adhesive or resin sealant.

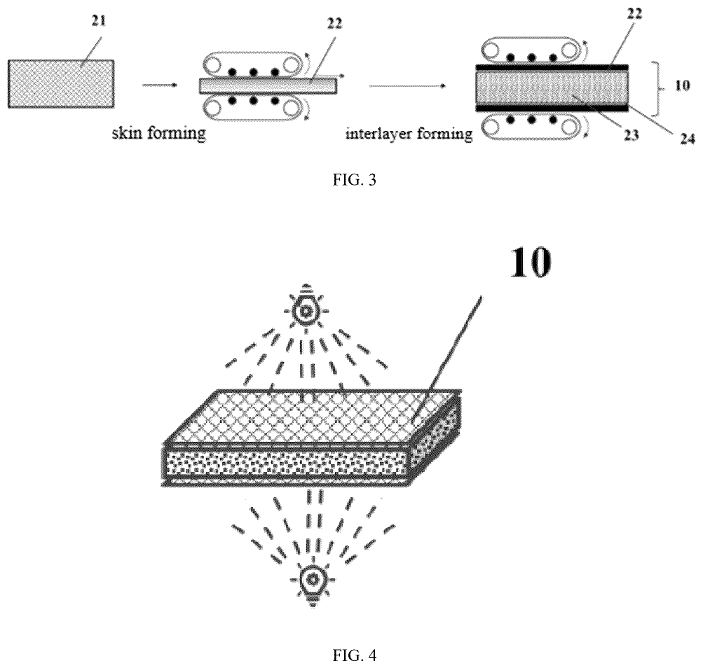

In some embodiments, the thermoplastic modular interlayer 10 includes a central core material layer 23, and thermoplastic skin layers 22 covering two opposite side surfaces of the core material layer 23. As shown in FIG. 3, two thermoplastic skin layers 22 are provided, respectively positioned on two opposite sides of the core material layer 23. The thermoplastic skin layers 22 and the core material layer 23 may be connected via a second intermediate layer 24. The second intermediate layer 24 may be one or more of adhesive film, resin film, and thermoplastic pre-preg tape.

In some embodiments, the thermoplastic skin layer 22 here may be a multi-layer fibrous tape layer. In some embodiments, it may be fabricated from thermoplastic prepreg tape 21 or a composition of thermoplastic resin powder and dry fibers according to different layup structures. Specifically, layup may be performed in a +/−45° orientation, followed by continuous compression molding to prepare the thermoplastic skin layer 22. The continuous compression molding here includes molding processes using a belt press, a steel belt press, or a continuous compression molding machine.

In some embodiments, the thickness of the thermoplastic skin layer 22 ranges from 1 mm to 10 mm. Specifically, the thermoplastic resin powder used may be one of polyimide, polyamide (nylon), polycarbonate, polyether ketone, polyether ether ketone, polyether ketone ketone, polypropylene, polyethylene, polysulfone, polyvinyl chloride, polyurethane, polyacetal, polyether nitrile, polymethacrylate, polyphenylene sulfide, polylactic acid, and polystyrene.

In some embodiments, the thermoplastic pre-preg tape 21 is one or more of unidirectional pre-preg tape, fabric pre-preg tape, twill pre-preg tape, biaxial or multiaxial pre-preg tape, with a thickness of 0.1 mm to 2 mm and a fiber mass fraction of 40% to 95%. Herein, the continuous fibers used in the thermoplastic pre-preg tape 21 may be one or more of glass fibers, ceramic fibers, metal fibers, carbon fibers, basalt fibers, regenerated fibers, and synthetic fibers.

In some embodiments, the thickness of the core material layer 23 ranges from 5 mm to 100 mm, and the core material used is one or more of balsa wood, PET (polyethylene terephthalate), PA (polyamide), PVC (polyvinyl chloride), PU (polyurethane), PP (polypropylene), and PC (polycarbonate).

In some embodiments, the thermoplastic skin layer 22 and the core material layer 23 are fixedly connected by welding or adhesive bonding, or via an adhesive film.

In some embodiments, the thermoplastic modular interlayer 10 includes multiple unit modules, where the number of unit modules at a same chordwise position does not exceed 5, and adjacent unit modules are connected by adhesive bonding or welding, and reinforced using the thermoplastic skin layer 22.

In some embodiments, the continuous thermosetting web flange 11 has a “π”-shaped cross-section with a web flange angle of 60° to 150° and a web flange width of 50 mm to 250 mm, and conforms to the contour of the wind turbine blade housing. When connecting to the thermoplastic modular interlayer 10, the π-shaped opening region can wrap around the thermoplastic modular interlayer 10 on three sides to achieve fixed connection. In some embodiments, the continuous thermosetting web flange 11 may have an “L”-shaped or “T”-shaped cross-section.

In some embodiments, an opening width of the “π”-shaped continuous thermosetting web flange 11 is 0 mm to 10 mm wider than the thermoplastic modular interlayer.

In some embodiments, the continuous thermosetting web flange 11 is formed by infusion or pultrusion of thermosetting resin and dry reinforcing fibers.

In some embodiments, the thermosetting resin is one of epoxy resin, polyurethane resin, unsaturated polyester, and vinyl ester resin.

In some embodiments, the dry reinforcing fibers are one or more of glass fibers, ceramic fibers, metal fibers, carbon fibers, basalt fibers, regenerated fibers, and synthetic fibers.

In some embodiments, the continuous thermosetting web flange 11 remains continuous in the axial direction or is segmented according to the design of the wind turbine blade, with the number of segments not exceeding 3. When the continuous thermosetting web flange 11 is segmented, the production of each segment is continuous.

In some embodiments, the thermoplastic modular interlayer 10 may be fixedly connected to the continuous thermosetting web flange 11 via a third intermediate layer 31 formed by resin bonding or structural adhesive bonding. Specifically, when using resin bonding, dry reinforcing fibers are laid on three sides of the thermoplastic modular interlayer 10, and are then cured and formed via processes such as vacuum infusion (to obtain the continuous thermosetting web flange 11), achieving connection with the blade housing.

In some embodiments, as shown in FIG. 4, the thermoplastic modular interlayer 10 is further subjected to surface pretreatment, which can activate the thermoplastic surface, thereby enhancing interfacial performance and improving the connection stability between the continuous thermosetting web flange 11 and the thermoplastic modular interlayer 10.

In some embodiments, the surface pretreatment may be performed using one or more of the following methods: plasma treatment, ultraviolet irradiation, electron beam treatment, sandblasting, or gamma ray irradiation.

The present disclosure further provides a manufacturing method for the modular thermoplastic web structure. Depending on the connection methods between the continuous thermosetting web flange 11 and the thermoplastic modular interlayer 10, the present disclosure provides at least two forming methods as follows.

The first forming method involves prefabricating the continuous thermosetting web flange 11, and includes: (1) preparing a thermoplastic skin layer 22 using thermoplastic pre-preg tape 21, compounding the thermoplastic skin layer 22 with a core material layer 23 to obtain a thermoplastic modular interlayer 10, and cutting the thermoplastic modular interlayer to appropriate dimensions; (2) preparing two continuous thermosetting web flanges 11 using thermosetting resin and dry reinforcing fibers; and (3) performing surface pretreatment on the thermoplastic modular interlayer 10, and fixedly connecting the resultant thermoplastic modular interlayer to the two continuous thermosetting web flanges 11.

The second forming method adopts the method of co-infusing the continuous thermosetting web flange 11 accompanied by the thermoplastic modular interlayer 10, or co-infusing the thermosetting web flange 11 accompanied by the thermoplastic modular interlayer 10 and the blade housing. It may specifically include: (A) preparing a thermoplastic skin layer using thermoplastic pre-preg tape, compounding the thermoplastic skin layer with a core material layer to obtain a thermoplastic modular interlayer, and cutting the thermoplastic modular interlayer to appropriate dimensions; and (B) performing surface pretreatment on the thermoplastic modular interlayer, laying dry reinforcing fibers between web flange molds and the thermoplastic modular interlayer, and infusing and curing to form two continuous thermosetting web flanges fixedly connected to two opposite ends of the thermoplastic modular interlayer.

Alternatively, the method includes: (I) preparing a thermoplastic skin layer using thermoplastic pre-preg tape, compounding the thermoplastic skin layer with a core material layer to obtain a thermoplastic modular interlayer, and cutting the thermoplastic modular interlayer to appropriate dimensions; and (II) performing surface pretreatment on the thermoplastic modular interlayer, laying dry reinforcing fibers in a space between a wind turbine blade housing and the thermoplastic modular interlayer, and infusing and curing to form two continuous thermosetting web flanges fixedly connected to two opposite ends of the thermoplastic modular interlayer.

Each of the above embodiments may be implemented individually or in any combination. The above embodiments will be described in more detail below in conjunction with specific examples.

### Comparative Example 1: Production of Thermosetting Web

1) Lay dry fibers and dry core materials on a web mold, perform vacuum infusion process with epoxy 180/185 resin, biaxial 800 fibers, and PET foam, and cure at 70° C. to fabricate the thermosetting web.

It was found that the thermosetting-thermosetting interface (i.e., the interface between the thermosetting web flange and the thermosetting sandwich interlayer) exhibits a lap shear strength of 35.3 MPa.

### Comparative Example 2: Bonding of Continuous Thermosetting Web Flange 11 and Thermoplastic Modular Interlayer 10

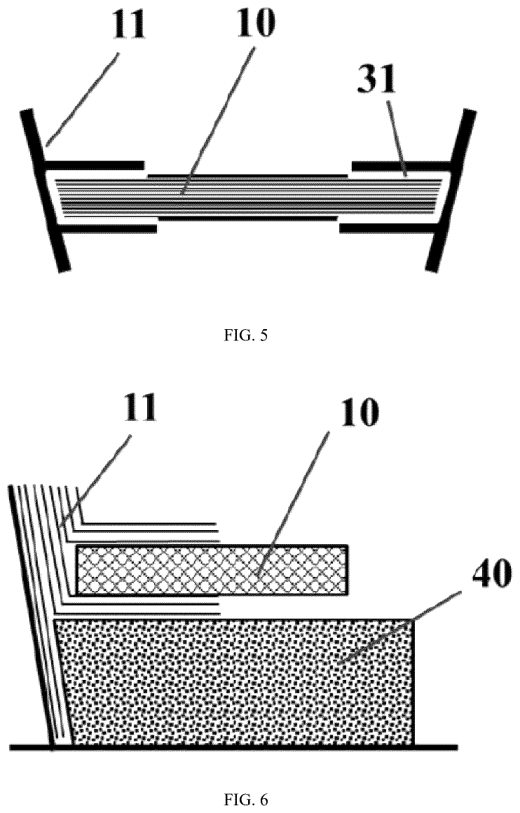

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 5, place the thermoplastic modular interlayer 10 on a platform, place two continuous thermosetting web flanges 11 on two opposite sides, fix using a vacuum bag, bond and cure with epoxy adhesive to form the third intermediate layer 31, thereby obtaining the modular thermoplastic web.

It was found that the thermosetting-thermoplastic interface (i.e., the interface between the thermosetting web flange and the thermoplastic modular interlayer) without surface pretreatment exhibits a lap shear strength of 12.9 MPa.

### Comparative Example 3: Co-Infusion of Continuous Thermosetting Web Flange 11 Accompanied by Thermoplastic Modular Interlayer 10

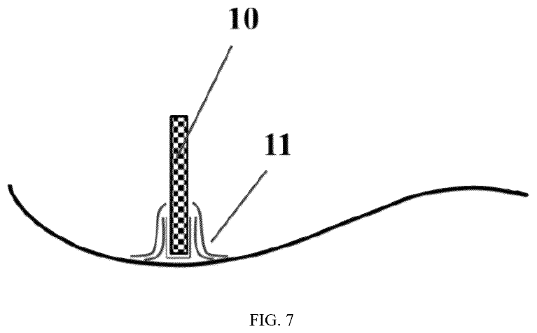

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 6, use a small web flange mold (i.e., flange mold 40), lay biaxial 800 fibers on two sides of the thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web.

It was found that the thermosetting-thermoplastic interface without surface pretreatment exhibits a lap shear strength of 15.2 MPa.

### Embodiment 1: Prefabrication of Continuous Thermosetting Web Flange 11

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 (i.e. sandwich structure) by continuous compression molding the thermoplastic skin layer 22, nylon adhesive film (i.e., second intermediate layer 24), and PET foam (i.e., core material layer 23); Subsequently, as shown in FIG. 4, treat the thermoplastic skin layer 22 using plasma (with air as the plasma-generating gas, a discharge power of 300 W, and a gas pressure of 0.3 kPa) for 2 treatments of 30 seconds each, with an effective open time (i.e., the effective activation period after surface pretreatment) of 2 hours.
3) Use a small web flange mold, lay biaxial 800 fibers, perform vacuum infusion process with epoxy 180/185 resin, and cure at 70° C. to prepare the thermosetting web flange 11.
4) As shown in FIG. 5, place the thermoplastic modular interlayer 10 on a platform, place two continuous thermosetting web flanges 11 on two opposite sides, fix using a vacuum bag, bond and cure with epoxy adhesive to form the third intermediate layer 31, thereby obtaining the modular thermoplastic web. It was found that the thermosetting-thermoplastic interface with surface pretreatment exhibits a lap shear strength of 38.4 MPa.

### Embodiment 2: Co-Infusion of Continuous Thermosetting Web Flange 11 Accompanied by Plasma-Treated Thermoplastic Modular Interlayer 10

1) Use polypropylene-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 4, treat the thermoplastic skin layer 22 using plasma (with air as the plasma-generating gas, a discharge power of 300 W, and a gas pressure of 0.3 kPa) for 2 treatments of 30 seconds each, with an effective open time (i.e., the effective activation period after surface pretreatment) of 2 hours.
4) As shown in FIG. 6, use a small web flange mold (i.e., flange mold 40), lay biaxial 800 fibers on two sides of the treated thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web. It was found that the thermosetting-thermoplastic interface with surface pretreatment exhibits a lap shear strength of 40.7 MPa.

### Embodiment 3: Co-Infusion of Continuous Thermosetting Web Flange 11 Accompanied by Sandblasted Thermoplastic Modular Interlayer 10

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 4, treat the thermoplastic skin layer 22 using sandblasting for 60 seconds, with an effective open time of 3 hours.
4) As shown in FIG. 7, after the wind turbine blade housing is thermosetting-molded, erect the thermoplastic modular interlayer on the housing surface, lay biaxial 800 fibers on two sides of the treated thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web. It was found that the thermosetting-thermoplastic interface with surface pretreatment exhibits a lap shear strength of 38.9 MPa.

### Embodiment 4: Co-Infusion of Continuous Thermosetting Web Flange 11 Accompanied by Electron Beam-Treated Thermoplastic Modular Interlayer 10

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 4, treat the thermoplastic skin layer 22 using an electron beam (with a beam current of 10 mA and an electron beam energy of 1.8 MeV) for 45 seconds, with an effective open time of 2 hours.
4) As shown in FIG. 7, after the wind turbine blade housing is thermosetting-molded, erect the thermoplastic modular interlayer on the housing surface, lay biaxial 800 fibers on two sides of the treated thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web. It was found that the thermosetting-thermoplastic interface with surface pretreatment exhibits a lap shear strength of 39.3 MPa.

### Embodiment 5: Co-Infusion of Continuous Thermosetting Web Flange 11 Accompanied by Gamma Ray-Treated Thermoplastic Modular Interlayer 10

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 4, treat the thermoplastic skin layer 22 using gamma rays (with an irradiation energy of 3.5 MeV) for 45 seconds, with an effective open time of 3 hours.
4) As shown in FIG. 7, after the wind turbine blade housing is thermosetting-molded, erect the thermoplastic modular interlayer on the housing surface, lay biaxial 800 fibers on two sides of the treated thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web. It was found that the thermosetting-thermoplastic interface with surface pretreatment exhibits a lap shear strength of 37.7 MPa.

### Embodiment 6: Co-Infusion of Continuous Thermosetting Web Flange 11 Accompanied by Ultraviolet-Treated Thermoplastic Modular Interlayer 10

1) Use nylon-based thermoplastic pre-preg tape 21, perform layup in a +/−45° orientation, and then prepare the thermoplastic skin layer 22 via continuous compression molding.
2) Prepare the thermoplastic modular interlayer 10 by continuous compression molding the thermoplastic skin layer 22, nylon adhesive film (i.e., second intermediate layer 24), and PET foam (i.e., core material layer 23).
3) As shown in FIG. 4, treat the thermoplastic skin layer 22 using ultraviolet light (with a wavelength of 350 nm and a power of 25 W) for 2 treatments of 100 s each, with an effective open time of 2 hours.
4) As shown in FIG. 7, after the wind turbine blade housing is thermosetting-molded, erect the thermoplastic modular interlayer on the housing surface, lay biaxial 800 fibers on two sides of the treated thermoplastic skin layer 22, perform vacuum infusion process with epoxy 180/185 resin, and cure at 70° C. to prepare the thermosetting web flange 11, where the thermosetting web flange 11 consolidates and forms with the thermoplastic modular interlayer 10 at the same time to obtain the modular thermoplastic web. It was found that the thermosetting-thermoplastic interface with surface pretreatment exhibits a lap shear strength of 33.9 MPa.

The epoxy 180/185 resin used in the above comparative examples and embodiments is a two-component epoxy resin (i.e., TECHSTORM 180/185) commonly used for vacuum infusion of wind turbine blades in this field. In specific implementation processes, based on practical needs, those skilled in the art may also choose other types or grades of epoxy resins, or choose thermosetting resins such as polyurethane resins, unsaturated polyesters, and vinyl ester resins.

In summary, the surface pretreatment effects of the prepared thermoplastic modular interlayer were tested, with the samples divided into 3 comparative groups and 6 experimental groups. Among them, the comparative groups underwent no pretreatment, while the 6 experimental groups were subjected to surface pretreatment under different parameter conditions.

TABLE 1

| | | Handling | Lap Shear |
|---|---|---|---|
| Samples | Interface Type | Method | Strength |
| Comparative | thermosetting-thermosetting- | Without | 35.3 MPa |
| Example 1 | co-infusion | pretreatment | |
| Comparative | thermosetting-thermoplastic- | Without | 12.9 MPa |
| Example 2 | bonding | pretreatment | |
| Comparative | thermosetting-thermoplastic- | Without | 15.2 MPa |
| Example 3 | co-infusion | pretreatment | |
| Embodiment 1 | thermosetting-thermoplastic- | Plasma | 38.4 MPa |
| | bonding | pretreatment | |
| Embodiment 2 | thermosetting-thermoplastic- | Plasma | 40.7 MPa |
| | co-infusion | pretreatment | |
| Embodiment 3 | thermosetting-thermoplastic- | Sandblasting | 38.9 MPa |
| | co-infusion | pretreatment | |
| Embodiment 4 | thermosetting-thermoplastic- | Electron | 39.3 MPa |
| | co-infusion | beam | |
| | | pretreatment | |
| Embodiment 5 | thermosetting-thermoplastic- | Gamma ray | 37.7 MPa |
| | co-infusion | pretreatment | |
| Embodiment 6 | thermosetting-thermoplastic- | UV | 33.9 MPa |
| | co-infusion | pretreatment | |

Based on the above content, it can be seen that after pretreatment such as plasma treatment is applied to the surface of the thermoplastic skin, the performance of the thermosetting-thermoplastic interface is significantly improved, thereby facilitating the connection and assembly of the thermosetting web flange with thermoplastic skin via methods such as co-infusion or bonding to fabricate wind turbine blade webs.

It can be seen that the present disclosure significantly increases the surface energy of the product by pretreating the surface of the thermoplastic skin made of nylon or polypropylene, thereby enhancing the thermoplastic-thermosetting interfacial performance and enabling the production of modular thermoplastic webs. Therefore, the present disclosure adopts the combination of a continuous thermosetting flange and a modular thermoplastic interlayer, utilizing continuous compression molding equipment for production. On one hand, this enables continuous production of web interlayer, effectively reducing quality defects. On the other hand, the continuous thermosetting web flange can utilize smaller molds or blade housing to achieving bonding with the housing by conventional bonding or co-infusion, thereby reducing mold investment. Additionally, the use of high-efficiency surface treatment techniques can significantly enhance the performance of the thermosetting-thermoplastic interface, ensuring product reliability.

The above description of the embodiments is intended to facilitate understanding and application of the present disclosure by those of ordinary skill in the art. Those familiar with the art can easily make various modifications to these embodiments and apply the general principles described herein to other embodiments without creative efforts. Therefore, the present disclosure is not limited to the above embodiments, and any improvements and modifications made by those skilled in the art based on the disclosure of the present application, without departing from the scope of the present application, shall fall within the scope of protection of the present application.

What is claimed is:

1. A modular thermoplastic web structure for wind power generation, comprising:
two continuous thermosetting web flanges fixedly connectable to a wind turbine blade housing; and
a thermoplastic modular interlayer, disposed between the two continuous thermosetting web flanges and having two opposite ends fixedly and respectively connected to the two continuous thermosetting web flanges.

2. The modular thermoplastic web structure for wind power generation according to claim 1, wherein the thermoplastic modular interlayer comprises a central core material layer, and thermoplastic skin layers covering two opposite side surfaces of the core material layer;
the thermoplastic skin layers are fabricated from thermoplastic pre-preg tape, thermoplastic film, interwoven thermoplastic-thermosetting fibers, or a composition of thermoplastic resin powder and dry fibers according to different layup structures.

3. The modular thermoplastic web structure for wind power generation according to claim 2, wherein a thickness of the thermoplastic skin layer ranges from 1 mm to 10 mm, and the thermoplastic resin powder is one or any combination of polyimide, polyamide (nylon), polycarbonate, polyether ketone, polyether ether ketone, polyether ketone ketone, polypropylene, polyethylene, polysulfone, polyvinyl chloride, polyurethane, polyacetal, polyether nitrile, polymethacrylate, polyphenylene sulfide, polylactic acid, and polystyrene;
the thermoplastic pre-preg tape is one or any combination of unidirectional pre-preg tape, fabric pre-preg tape, twill pre-preg tape, biaxial or multiaxial pre-preg tape, with a thickness of 0.1 mm to 2 mm and a fiber mass fraction of 40% to 95%;
a thickness of the core material layer ranges from 5 mm to 100 mm, and a core material thereof is one or any combination of balsa wood, polyethylene terephthalate (PET), polyamide (PA), polyvinyl chloride (PVC), polyurethane (PU), polypropylene (PP), and polycarbonate (PC);
the thermoplastic skin layer and the core material layer are fixedly connected by welding or adhesive bonding, or via an adhesive film.

4. The modular thermoplastic web structure for wind power generation according to claim 2, wherein the thermoplastic modular interlayer comprises a plurality of unit modules, wherein a number of the plurality of unit modules at a same chordwise position does not exceed 5, and adjacent unit modules are connected by adhesive bonding or welding, and are reinforced using the thermoplastic skin layer.

5. The modular thermoplastic web structure for wind power generation according to claim 3, wherein the thermoplastic modular interlayer comprises a plurality of unit modules, wherein a number of the plurality of unit modules at a same chordwise position does not exceed 5, and adjacent unit modules are connected by adhesive bonding or welding, and are reinforced using the thermoplastic skin layer.

6. The modular thermoplastic web structure for wind power generation according to claim 1, wherein each continuous thermosetting web flange has a “π”-shaped, “L”-shaped, or “T”-shaped cross-section with an angle of 60° to 150° and a width of 50 mm to 250 mm, and conforms to a contour of the wind turbine blade housing;
an opening width of the “π”-shaped continuous thermosetting web flange is 0 mm to 10 mm wider than the thermoplastic modular interlayer.

7. The modular thermoplastic web structure for wind power generation according to claim 1, wherein the continuous thermosetting web flange is formed by infusion or pultrusion of thermosetting resin and dry reinforcing fibers;
the thermosetting resin is one of epoxy resin, polyurethane resin, unsaturated polyester, and vinyl ester resin; and
the dry reinforcing fibers are one or any combination of glass fibers, ceramic fibers, metal fibers, carbon fibers, basalt fibers, regenerated fibers, and synthetic fibers.

8. The modular thermoplastic web structure for wind power generation according to claim 2, wherein the continuous thermosetting web flange is formed by infusion or pultrusion of thermosetting resin and dry reinforcing fibers;
the thermosetting resin is one of epoxy resin, polyurethane resin, unsaturated polyester, and vinyl ester resin; and
the dry reinforcing fibers are one or any combination of glass fibers, ceramic fibers, metal fibers, carbon fibers, basalt fibers, regenerated fibers, and synthetic fibers.

9. The modular thermoplastic web structure for wind power generation according to claim 3, wherein the continuous thermosetting web flange is formed by infusion or pultrusion of thermosetting resin and dry reinforcing fibers;
the thermosetting resin is one of epoxy resin, polyurethane resin, unsaturated polyester, and vinyl ester resin; and
the dry reinforcing fibers are one or any combination of glass fibers, ceramic fibers, metal fibers, carbon fibers, basalt fibers, regenerated fibers, and synthetic fibers.

10. The modular thermoplastic web structure for wind power generation according to claim 4, wherein the continuous thermosetting web flange is formed by infusion or pultrusion of thermosetting resin and dry reinforcing fibers;
the thermosetting resin is one of epoxy resin, polyurethane resin, unsaturated polyester, and vinyl ester resin; and
the dry reinforcing fibers are one or any combination of glass fibers, ceramic fibers, metal fibers, carbon fibers, basalt fibers, regenerated fibers, and synthetic fibers.

11. The modular thermoplastic web structure for wind power generation according to claim 5, wherein the continuous thermosetting web flange is formed by infusion or pultrusion of thermosetting resin and dry reinforcing fibers;
the thermosetting resin is one of epoxy resin, polyurethane resin, unsaturated polyester, and vinyl ester resin; and
the dry reinforcing fibers are one or any combination of glass fibers, ceramic fibers, metal fibers, carbon fibers, basalt fibers, regenerated fibers, and synthetic fibers.

12. The modular thermoplastic web structure for wind power generation according to claim 1, wherein the continuous thermosetting web flange remains continuous in an axial direction or is segmented according to a design of the wind turbine blade, and in a case that the continuous thermosetting web flange is segmented, production of each segment is continuous.

13. The modular thermoplastic web structure for wind power generation according to claim 1, wherein the thermoplastic modular interlayer is subjected to surface pretreatment, and the surface pretreatment is performed using one or more of plasma treatment, ultraviolet irradiation, electron beam treatment, sandblasting, and gamma ray irradiation.

14. The modular thermoplastic web structure for wind power generation according to claim 2, wherein the thermoplastic modular interlayer is subjected to surface pretreatment, and the surface pretreatment is performed using one or more of plasma treatment, ultraviolet irradiation, electron beam treatment, sandblasting, and gamma ray irradiation.

15. The modular thermoplastic web structure for wind power generation according to claim 3, wherein the thermoplastic modular interlayer is subjected to surface pretreatment, and the surface pretreatment is performed using one or more of plasma treatment, ultraviolet irradiation, electron beam treatment, sandblasting, and gamma ray irradiation.

16. The modular thermoplastic web structure for wind power generation according to claim 4, wherein the thermoplastic modular interlayer is subjected to surface pretreatment, and the surface pretreatment is performed using one or more of plasma treatment, ultraviolet irradiation, electron beam treatment, sandblasting, and gamma ray irradiation.

17. The modular thermoplastic web structure for wind power generation according to claim 5, wherein the thermoplastic modular interlayer is subjected to surface pretreatment, and the surface pretreatment is performed using one or more of plasma treatment, ultraviolet irradiation, electron beam treatment, sandblasting, and gamma ray irradiation.

18. A wind turbine blade, comprising a wind turbine blade housing and the modular thermoplastic web structure for wind power generation according to claim 1.
